(19) United States
(12) Patent Application Publication
(10) Pub. No.: US 2009/0150250 A1
(43) Pub. Date: Jun. 11, 2009

(54) Method and apparatus for supervising a sale of a product between a buyer and a seller

(76) Inventor: Henrik Sevegran, Helsingborg (SE)

Correspondence Address: Steven S. Payne, P.O. Box 65024, Washington, DC, 20035, US

(21) Appl. No.: 11/652,338

(22) Filed: Jan. 11, 2007

(51) Int. Cl. G06Q 30/00

(52) U.S. Cl. 705/26

(57) ABSTRACT

A method and apparatus for supervising a sale of a product between a buyer and a seller using a supervision transaction system is disclosed. The seller is notified to send the product to a system hub. The buyer is notified that the product has been received at the system hub and is ready for inspection. The seller is notified of the transaction status after the buyer inspects the product at the system hub.

### FIELD OF THE INVENTION

The present invention relates to secure transactions and more particularly to a method and system for supervising a sale so as to provide a safe transaction for buyers and sellers primarily trading over the Internet.

### BACKGROUND OF THE INVENTION

The use of the Internet as a means for conducting business transactions for the sale of goods and products has exploded in the last decade. People can now buy and sell all kinds of products, both new and used, over the Internet using, for example, auction sites such as eBay®. The potential of the Internet is being limited because some people are not comfortable with buying and selling products over the Internet. People fear that they may be cheated in some manner or they want to actually see the product before they pay for the product.

There are existing methods for trying to provide a safe environment for online transactions such as online escrow services, payment at delivery and user feedback systems of different auction sites. There are however problems with using each of these methods as will be described below.

Online escrow services attempt to protect the buyer by allowing the buyer to receive merchandise before the seller is paid. For example, the buyer and seller can agree to use an escrow service for the transaction. The buyer then transfers the funds, which he/she is paying for the product, into an account of the escrow company. The seller is then notified that the funds have been received by the escrow company and the seller can then send the product to the buyer. When the buyer receives the product, the buyer can inspect the product and decide whether to accept the product. If the buyer accepts the product, the escrow company is notified and the escrow company can then transfer the funds to the seller.

This method may seem fairly safe and simple at first glance, but there are circumstances when this type of service will fall short. First, the buyers are often required to send the funds to the escrow account using an online credit card transaction. During this procedure the buyer is exposed to various risks, for example, the website may be exposed to phishing attempts. There is also a risk that someone may illegally break into the escrow company's system and steal the buyer's credit card information. In addition, agencies such as the Better Business Bureau in the United States and the ECC in Europe repeatedly warn online consumers of the increasing number of false escrow services where the fraudulent seller or buyer are working with the false escrow service to cheat innocent buyers and sellers.

Even if consumers use well known escrow services such as PAYPAL® or ESCROW.COM®, problems may still arise. Consider for example, a transaction between a buyer and seller for a transaction for a ROLEX® watch worth $2000. The buyer transfers the funds to the escrow company, which in turn notifies the seller to send the watch to the buyer. The buyer sends a package to the seller but instead of sending a real ROLEX® watch the seller sends a fake watch or the package is empty. The buyer notifies the escrow service of the problem and demands the return of their money. When asked by the escrow company, the seller says that a real Rolex® watch was sent to the buyer and the seller demands payment for the real watch. If the seller is actually engaging in fraudulent behavior, the seller has already prepared the scam by having a real ROLEX® watch photographed and a witness who can testify that they saw the real watch packaged and sent to the buyer. In addition, the seller may have built up a positive customer rating with the escrow company by receiving positive feedback that has been built up through an auction site. The escrow company will tend to favor the seller in this case since the seller is generating transaction fees over time. As a result, the seller will receive the funds and the buyer is left with a loss.

The escrow system can also be a problem for well intentioned sellers. For example, the seller may actually send a real watch to the buyer but the fraudulent buyer might claim that the watch is a fake and demands the return of his money from the escrow company. There is no good solution to the problem since it is the seller's word against the buyer's word.

Some logistics companies offer the service pay on delivery or cash on delivery. In this system, a product is ordered online by the buyer and then paid for on delivery of the product. While this system ensures the buyer that the package will be delivered, the buyer still has to pay for the product before he/she can take possession and opens the product. Thus, if the product is wrong or missing, the buyer has to ask for the return of their money.

As mentioned above, some auction sites have instituted a customer feedback system in which buyers and sellers rate their experiences of past transactions. The theory behind this system is that buyers and sellers will not deal with people who have a negative ratings. The problem with this system is the ability of both buyers and sellers to manipulate their status. This could be done over time by selling under priced items which will most likely generate positive feedback. This positive feedback is then used as an advantage on the unaware counterpart and a potential fraud can now more easily be concluded. Thus, the feedback system on which most auction sites and escrow companies rely on generate a false sense of security since the system can be easily manipulated.

Thus, there is a need for a new method and apparatus for supervising a sale so as to provide a safe transaction for buyers and sellers overcomes the problems cited above.

### SUMMARY OF THE INVENTION

It is therefore a feature and advantage of the present invention to provide a method and apparatus for supervising a sale of a product so as to provide a safe transaction wherein the buyer inspects the product while under supervision.

In accordance with one embodiment of the present invention, a method for supervising a sale of a product between a buyer and a seller using a supervision transaction system is disclosed. The seller is notified to send the product to a system hub. The buyer is then notified that the product has been received at the system hub and is ready for inspection. The seller is then notified of the transaction status after the buyer inspects the product at the system hub.

In accordance with another embodiment of the invention, a supervision transaction system for supervising a sale of a product between a buyer and a seller is disclosed. The supervision transaction system comprises a central station, a plurality of system hubs in communication with the central station, wherein the central station notifies the seller to send the product to a system hub, notifies the buyer that the product has been received at the system hub and is ready for inspection, notifies the seller of the transaction status after the buyer inspects the product at the system hub.

According to another embodiment of the invention, a computer-readable medium having embodied thereon a computer program for processing by a computer, the computer program comprising: a first code segment for notifying the seller to send the product to a system hub; a second code segment for notifying the buyer that the product has been received at the system hub and is ready for inspection; and a third code segment for notifying the seller of the transaction status after the buyer inspects the product at the system hub.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will now be described, by way of example, with reference to the accompanying drawings, wherein:

FIG. 1 discloses a transaction environment according to one embodiment of the invention;

FIG. 2 illustrates a supervision transaction device according to one embodiment of the invention;

FIGS. 3(a)-(e) are flowcharts illustrating a method for supervising a sale of a product between a buyer and a seller using a supervision transaction system according to one embodiment of the invention; and

FIG. 4 illustrates a computer readable medium according to one embodiment of the invention.

### DETAILED DESCRIPTION

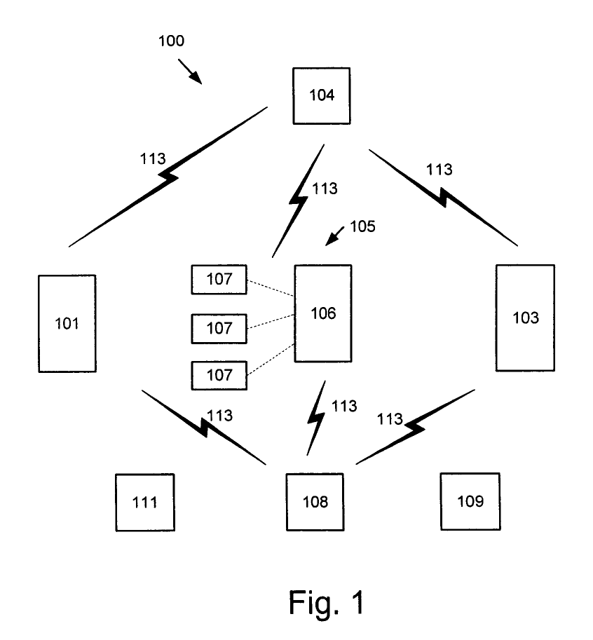

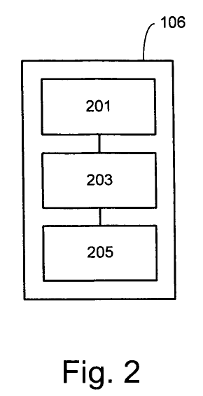

FIG. 1 illustrates a transaction environment 100 according to one embodiment of the invention. In the illustrative example, a seller 103 is selling a product over the Internet 104, for example, using an auction site. The product is offered for sale and the buyer 101 decides to buy the product. The buyer 101 and seller 103 agree to use the inventive supervision transaction system 105 to supervise or oversee the completion of the agreed upon transaction for the sale of the product. The supervision transaction system 105 has a central station 106 and a plurality of system hubs 107. As illustrated in FIG. 2, the central station 106 comprises a communication interface 201, a processor 203 with associated software capable of performing all of the tasks needed to successfully oversee the sale of the product, and a database 205.

As mentioned above, the supervision transaction system 105 has a plurality of system hubs 107. The system hubs can be any business with an actual store location that wants to join the supervision transaction system 105. The system hubs 107 have access to path of the supervision transaction system 105 through cashier machines/computers. Every system hub 107 has different capacity, e.g. storage space and what size of package the hub can handle, domain specification, e.g. a jewelry shop handles jewelry, watches, etc., and attributes, e.g. geographic location, telephone, email, hours of operation, commission rate, guaranteed level of commission, owner/responsible, authorized users/employees.

The supervision transaction system 105 is connected to various communication systems e.g., the Internet 104, telecommunication systems 108, etc. through various communication links 113. The supervision transaction system 105 is also connected to various shipping companies 109 involved in the transportation of the package to and from the seller and various financial companies 111 as well as be described in more detail below.

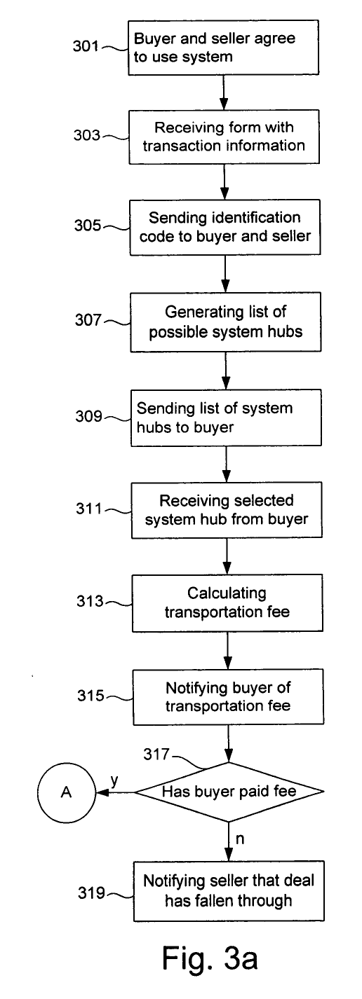

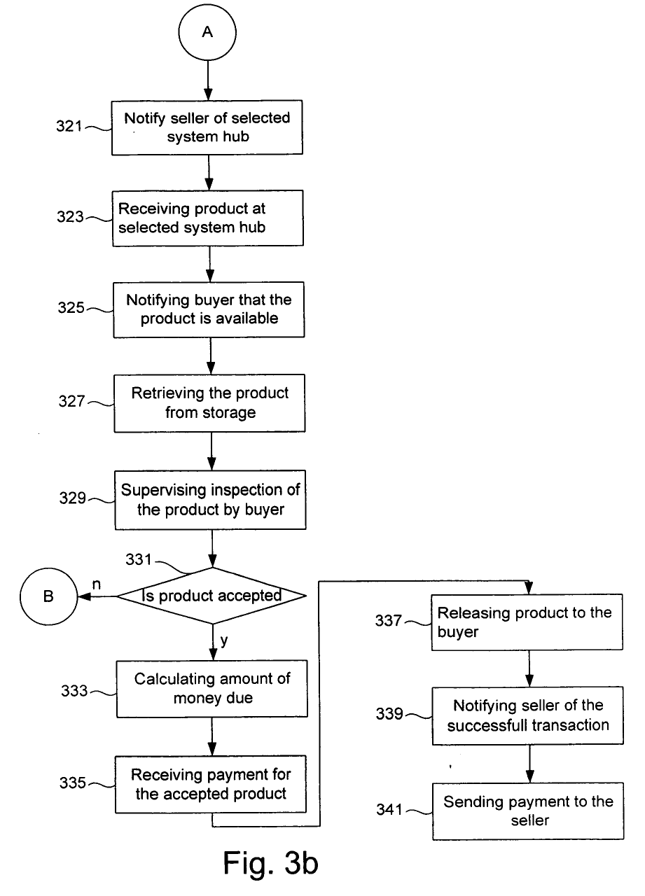

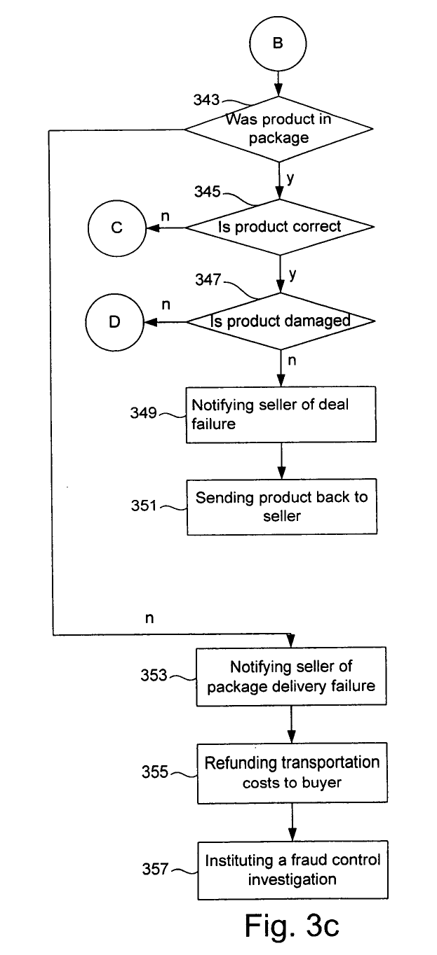

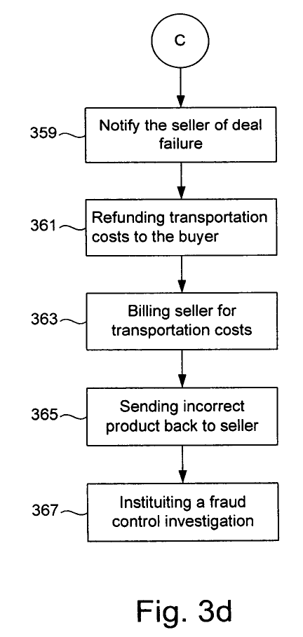

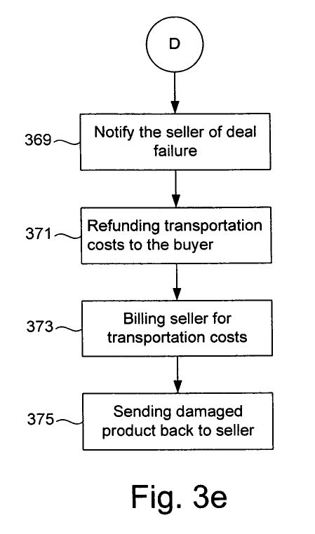

One embodiment of the invention will now be described with reference to FIGS. 3(a)-(e) which are flowcharts illustrating a method for supervising a sale. In step 301, the buyer 101 and seller 103 have come to an agreement on the sale of a product and have selected the supervision transaction system 105 to oversee the delivery and completion of the sale. The buyer 101 and seller 103 have reached an agreement on price, and who should pay for shipping and insurance. The seller 103 then fills out a form(s) from the system 105 preferably via the internet 104 which gives the system 105 the information needed to oversee the transaction. This information includes but is not limited to names and contact information of the buyer and seller, e.g. email address, cell phone number, address, etc., the type of product being sold, size of the product and price information. When the system 105 receives the form with all of the information about the transaction in step 303, the system creates a unique identification code for the transaction. The identification code is then sent to the buyer 101 and seller 103 in step 305.

In one embodiment of the invention, the system 105 may select a system hub 107 for the buyer to use. The selected system hub 107 may be selected based on location, capacity, domain specialty or any of the other attributes listed above. Preferably, the system 105 will generate a list of possible system hubs 107 the buyer 101 can choose from in step 307. The list of possible hubs 107 may be created based on location, capacity, domain specialty or other attributes. For example, a system hub which is located close to the home of the buyer 101 that does not have the capacity to handle the product will not be included in the list. The list of possible system hubs 107 can be sent to the buyer through various communication systems, but is preferably sent via email and/or short messaging system (SMS) in step 309.

Once the buyer has selected a system hub 107, the selection is sent to the system 105 in step 311. In order to ensure the seriousness of the buyer to follow through with the transaction, the buyer 101 is now required to pre-pay the transportation costs of sending the product back to the seller 103 from the selected system hubs 107. This transaction fee is different from the transportation fee the buyer and seller have agreed upon for the shipment of the product from the seller 103 to the buyer 101. Thus, the system 105 calculates how much it will cost to send the package from the selected hub to the seller 103 in step 313. The system 105 then sends e.g. via email, SMS, a payment notice to the buyer 101 for the calculated transportation costs in step 315. According to one embodiment of the invention, the buyer 101 is asked to pay the transportation fee via a telephone based payment service connected to the system 105. By prepaying the transportation fee by phone, the buyer 101 is not exposed to the risk of entering credit card information online and the system 105 does not store any credit card information and is not subject to theft. In other embodiments of the invention, the buyer may be offered the option of paying online or over the telephone and the invention is not limited thereto.

If it is determined in step 317 that the buyer has not paid the transportation fee within a predetermined period of time, the system 105 will notify the seller 103 that the deal has fallen through in step 319. If the buyer 101 does pay the transportation fee, the system 105 notifies the seller that the fee has been paid and that the product should be sent to the selected system hub 107 in step 321. The seller 103 then prints out a generated form with the unique identification code and attaches the form to the packaging of the product or manually writes the identification code on the package. The package is then sent via a shipping service 109 to the selected system hub 107.

When the product arrives at the selected system hub 107, the identification code is scanned or entered into the system 105 and the system generates a status indication that the package has arrived and suggests a proper place for storage in step 323. In response to the receipt of the package, the system 105 notifies the buyer 101, in step 325, that the package has been received and is available for inspection and pick-up.

When the buyer 101 arrives at the selected system hub 107, the buyer 101 identifies the transaction using the transaction identification code. The package is retrieved from storage, preferably by using the transaction identification code, and presented to the buyer 101, in step 327. It is important to note that the package has not been opened or inspected prior to the package being presented to the buyer 101. The buyer 101 then opens the package and inspects the product in the company of an employee of the system hub 107, in step 329.

At this point in the transaction, the buyer 101 has several options: accept the product, refuse acceptance of the product, or refuse to continue with the transaction because the package does not contain the correct product or does not contain a product at all, or the product is broken or defective in some way. If the buyer 101, decides to accept the product in step 331, the system 105 calculates the amount of money due to be paid based on the transaction information entered into the system 105, in step 333. In the alternative, the amount due may have been previously calculated by the seller and entered in the transaction information. The buyer 101 pays for the product using cash, credit card, debit card, etc. in step 335 using standard credit card/debit card machines located at the system hub 107. As a result, sensitive financial information e.g. credit card or debit card numbers are not kept by the system 105 and can not be stolen. Once the payment is received, the product is released to the buyer 101 in step 337. The system 105 then notifies the seller 103 that the transaction has been successfully completed in step 339. The system 105 then sends the payment for the product minus any commission charged by the service 105 to the seller's account in step 341.

If the buyer refuses to continue with the transaction, it is first determined if a product was contained in the package in step 343. If there is a product in the package, it is then determined if the product is the correct product in step 345. The correct product should be identified in the transaction information allowing the system hub to determine if the seller 103 sent the correct product. It is then determined if the product is damaged or defective in some manner in step 347. If the correct product was in fact sent and is undamaged, but the buyer has decided that he/she does not want to purchase the product, the system 105 informs the seller 103 of the deal failure in step 349. The system then uses the transportation fee obtained earlier from the buyer 101 to ship the product back to the seller 103 in step 351.

If it is determined in step 343 that the product was not contained in the package, the system notifies the seller 103 of package delivery failure in step 353. The system 105 then refunds the pre-paid transportation costs to the buyer 101 in step 355. Optionally, the system 105, may then follow up with the seller 103 to determine if the seller innocently or fraudulently sent the package without the agreed upon product and whether the seller 103 owes any fees to the system 105 for the failed transaction in step 357.

If it is determined in step 345 that the package contained an incorrect product, the system 105 notifies the seller of deal failure due to an incorrect product being in the package in step 359. The system 105 then refunds the pre-paid transportation fee to the buyer 101 in step 361. The system 105 then bills the seller 103 for the transportation costs for returning the incorrect product back to the seller 103 in step 363. Once the transportation fee has been paid by the seller 103, the incorrect product is sent back to the seller 103 in step 365. Optionally, the system 105 may also follow up with the seller 103 to determine if the seller 103 innocently or fraudulently sent the package with an incorrect product and whether the seller 103 owes the system 105 for any fees arising from the failed transaction in step 367.

If it is determined in step 347 that the product is correct but is damaged or defective and the buyer 101 elects not to complete the purchase of the product, the system 105 notifies the seller 103 of the deal failure based on damaged product in step 369. The system 105 then refunds the pre-paid transportation fee to the buyer 101 in step 371. The system 105 then bills the seller 103 for the transportation costs for returning the incorrect product back to the seller 103 in step 373. Once the transportation fee has been paid by the seller 103, the incorrect product is sent back to the seller 103 in step 375. In the alternative, the seller 103 may simply tell the system to discard the damaged product rather than returning the damaged product to the seller 103.

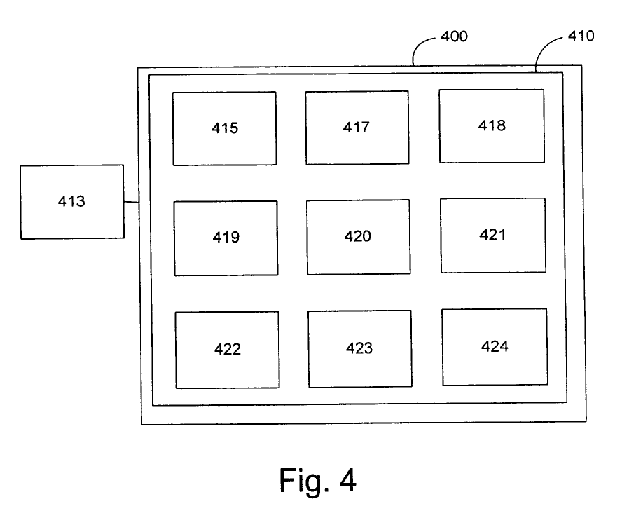

In another embodiment of the invention according to FIG. 4, a computer-readable medium is illustrated schematically. A computer-readable medium 400 has embodied thereon a computer program 410 for processing by a computer 413, the computer program for processing by a computer, the computer program comprising code segments for supervising a sale of a product between a buyer and a seller. The computer program comprises a first code segment 415 for generating a unique transaction identification code for each sale, a second code segment 417 for sending the transaction identification code to the buyer and seller, wherein the transaction identification code is used by the buyer, seller and system to identify the product, a third code segment 418 for generating a list of possible system hubs the buyer can use to inspect the product, a fourth code segment 419 for sending the list of possible hubs to the buyer so that the buyer can select the system hub to which the product should be shipped, a fifth code segment 420 for calculating transportation costs for returning the package to the seller from the system hub, a sixth code segment 421 for obtaining payment of transportation costs from the buyer prior to notifying the seller to send the product, a seventh code segment 422 for notifying the seller to send the product to a system hub, an eighth code segment 423 for notifying the buyer that the product has been received at the system hub and is ready for inspection, and a ninth code segment 424 for notifying the seller of the transaction status after the buyer inspects the product at the system hub.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method for supervising a sale of a product between a buyer and a seller using a supervision transaction system, comprising the steps of:
notifying the seller to send the product to a system hub,
notifying the buyer that the product has been received at the system hub and is ready for inspection,
notifying the seller of the transaction status after the buyer inspects the product at the system hub.

2. The method according to claim 1, further comprising the steps of:
generating a list of possible system hubs the buyer can use to inspect the product,
sending the list of possible hubs to the buyer so that the buyer can select the system hub to which the product should be shipped.

3. The method according to claim 2, wherein the list is generated based on at least one of geographic location, storage capacity, fee arrangements, and knowledge about type of product.

4. The method according to claim 2, wherein the list is sent to the buyer by at least one of email and short messaging service.

5. The method according to claim 1, further comprising the steps of:
calculating transportation costs for returning the package to the seller from the system hub,
obtaining payment of transportation costs from the buyer prior to notifying the seller to send the product.

6. The method according to claim 5, wherein a telephone based payment service is provided to the buyer for obtaining payment of the transportation costs.

7. The method according to claim 1, further comprising the steps of:
obtaining payment for the product from the buyer at the system hub if the buyer accepts the product,
paying seller for the product.

8. The method according to claim 1, further comprising the steps of:
notifying seller of deal failure if the buyer does not accept the product,
arranging for the product to be returned to the seller.

9. The method according to claim 5, further comprising the steps of:
notifying seller of package delivery failure when the product is missing or incorrect,
refunding the transportation costs to the buyer.

10. The method according to claim 1, further comprising the steps of:
generating a unique transaction identification code for each sale,
sending the transaction identification code to the buyer and seller, wherein the transaction identification code is used by the buyer, seller and system to identify the product.

11. The method according to claim 1, wherein the buyer is notified that the product has been received at the system hub by at least one of email and short messaging service.

12. A supervision transaction system for supervising a sale of a product between a buyer and a seller, comprising:
a central station,
a plurality of system hubs in communication with the central station,
wherein the central station notifies the seller to send the product to a system hub, notifies the buyer that the product has been received at the system hub and is ready for inspection, notifies the seller of the transaction status after the buyer inspects the product at the system hub.

13. The supervision transaction system according to claim 12, wherein the central station generates a list of possible system hubs the buyer can use to inspect the product, and sends the list of possible hubs to the buyer so that the buyer can select the system hub to which the product should be shipped.

14. The supervision transaction system according to claim 13, wherein the list is generated based on at least one of geographic location, storage capacity, fee arrangements, and knowledge about type of product.

15. The supervision transaction system according to claim 13, wherein the list is sent to the buyer by at least one of email and short messaging service.

16. The supervision transaction system according to claim 12, wherein the central station calculates transportation costs for returning the package to the seller from the system hub, obtains payment of transportation costs from the buyer prior to notifying the seller to send the product.

17. The supervision transaction system according to claim 16, wherein a telephone based payment service is provided to the buyer for obtaining payment of the transportation costs.

18. The supervision transaction system according to claim 12, wherein the central station obtains payment for the product from the buyer at the system hub if buyer accepts the product, and pays seller for the product.

19. The supervision transaction system according to claim 12, wherein the central station notifies the seller of deal failure if the buyer does not accept the product, and arranges for the product to be returned the product to the seller.

20. The supervision transaction system according to claim 16, wherein the central station notifies the seller of package delivery failure when product is missing or incorrect, and refunds the transportation costs to the buyer.

21. The supervision transaction system according to claim 12, wherein the central station generates a unique transaction identification code for each sale, and sends the transaction identification code to the buyer and seller, wherein the transaction identification code is used by the buyer, seller and system to identify the product.

22. The supervision transaction system according to claim 12, wherein the buyer is notified that the product has been received at the system hub by at least one of email and short messaging service.

23. The supervision transaction system according to claim 12, wherein the central station comprises a communication interface, a processor and a database.

24. A computer-readable medium having embodied thereon a computer program for processing by a processing device, the computer program comprising code segments for supervising a sale of a product between a buyer and a seller using a supervision transaction system, comprising:
a first code segment for notifying the seller to send the product to a system hub,
a second code segment for notifying the buyer that the product has been received at the system hub and is ready for inspection,
a third code segment for notifying the seller of the transaction status after the buyer inspects the product at the system hub.
